(19) United States
(12) Patent Application Publication
(10) Pub. No.: US 2003/0081954 A1
(43) Pub. Date: May 1, 2003

(54) Digital camera

(76) Inventors: Masahito Niikawa, Sakai-Shi (JP); Jun Minakuti, Sakai-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/272,796

(22) Filed: Oct. 17, 2002

(30) Foreign Application Priority Data
Oct. 19, 2001 (JP) P2001-322703

(51) Int. Cl. G03B 17/48

(52) U.S. Cl. 396/429

(57) ABSTRACT

The present invention provides a technique capable of properly associating captured image data with color conversion data such as an ICC profile in accordance with a color correction mode of the captured image data. When a color correction mode designated by the user is a “special image capturing OFF” mode in step S11, a digital camera sets so that a captured image is associated with an ICC profile for color image (step S31). In a “black and white” mode, the digital camera sets so that the captured image is associated with an ICC profile for black and white image (step S32). When the designated color correction mode is a “sepia” mode (or “saturation emphasizing” mode”), the digital camera sets to inhibit association of a captured image with an ICC profile (step S33).

This application is based on application No. 2001-322703 filed in Japan, the contents of which are hereby incorporated by reference.

### BACKGROUND OF THE INVENTION

1. Field of the Invention

The present invention relates to a digital camera capable of performing color correction.

2. Description of the Background Art

Each digital camera has a peculiar color reproduction characteristic. To reproduce colors faithfully in consideration of the peculiar color reproduction characteristic of each digital camera, there is a technique for performing color conversion by using color conversion data such as an ICC (International Color Consortium) profile.

In such a technique, color conversion data such as the ICC profile is stored in a memory card or the like of the digital camera. After that, by using the ICC profile read out from the memory card or the like, captured image data is subjected to color conversion, and the resultant data is displayed on a display screen. In such a manner, captured image data whose color reproduction characteristic peculiar to each digital camera is compensated can be output on the display screen of each of various display devices such as CRT and LCD. The data can be not only displayed on a display but also can be similarly printed on a paper medium or the like.

As the number of functions of a digital camera increases in recent years, some digital cameras come to have various kinds of color correction modes. For example, there is a digital camera having various color correction modes such as a saturation changing mode for changing saturation or chroma of captured image data, a sepia mode for correcting captured image data to a sepia image and, further, a black and white mode for correcting captured image data into a monochrome image. In such a digital camera, from a plurality of kinds of color correction modes, a desired color correction mode for each captured image data is selected by the user and designated.

In the conventional technique, however, at the time of taking the color reproduction characteristic peculiar to a digital camera into consideration, the same ICC profile is used for all of a plurality of captured images, and the kind of a color correction mode for each captured image is not considered. Specifically, in the case where a plurality of images are captured in various color correction modes, how to use color conversion data for each captured image data is not properly considered. Consequently, problems caused by the above exist.

For example, when a color converting process is performed by using a normal ICC profile (color conversion data) for a color image on an image in the black and white mode, the image in the black and white mode is colored by the color conversion with the ICC profile. More concretely, when monochrome data (gray scale data) in which only a luminance signal Y has various values (gray scale values) and each of other color difference signals (R-Y) and (B-Y) is expressed as zero is converted into an RGB space and, after that, color conversion is performed with an ICC profile, a half tone value in the gray scale is compensated so as to have some hue and/or saturation. Consequently, a captured image is converted to a so-called “colored image”.

### SUMMARY OF THE INVENTION

The present invention is directed to a digital camera capable of performing color correction.

A digital camera according to one aspect of the present invention includes a designating part for designating a color correction mode for captured image data from a plurality of color correction modes, and a setting part for setting color conversion data to be associated with the captured image data in accordance with the type of the color correction mode designated by the designating part.

With the configuration employed, in accordance with the type of the color correction mode designated by the designating part, color conversion data to be associated with captured image data is set. Thus, the captured image can be reproduced faithfully to the intention of the user.

A digital camera according to another aspect of the present invention includes a designating part for designating a color correction mode for captured image data from a plurality of color correction modes, and a setting part for setting whether color conversion data is associated with the captured image data or inhibited to be associated, in accordance with the type of the color correction mode designated by the designating part.

With the configuration employed, in accordance with the type of the color correction mode designated by the designating part, whether the captured image data is associated with any color conversion data or inhibited from being associated with color conversion data is set. Thus, the captured image data in a color correction mode requiring no color conversion data can be prevented from being associated with unnecessary color conversion data.

As described above, an object of the present invention is to provide a technique capable of properly associating color conversion data such as an ICC profile with each captured image data, in accordance with the color correction mode of each captured image data.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing a configuration of a main part of a digital camera according to an embodiment of the present invention;

FIG. 2 is a sectional view showing the configuration of the main part of the digital camera;

FIG. 3 is a rear view showing the configuration of the main part of the digital camera;

FIG. 4 is a functional block diagram of the digital camera;

FIG. 5 is a diagram for describing data stored in a memory card;

FIG. 6 is a diagram for describing an example of using a profile;

FIG. 7 is a flowchart showing a designating operation and a setting operation with respect to a color correction mode;

FIG. 8 is a view showing a screen for designating the color correction mode;

FIG. 9 is a conceptual diagram showing a detailed configuration of tag information regarding an image captured in a “special image capturing OFF” mode;

FIG. 10 is a conceptual diagram showing a detailed configuration of tag information regarding an image captured in a “black and white” mode;

FIG. 11 is a conceptual diagram showing a detailed configuration of tag information regarding an image captured in a “saturation emphasizing” mode; and

FIG. 12 is a diagram showing an example of a configuration of a camera profile (ICC profile) according to another embodiment.

### DESCRIPTION OF THE PREFERRED EMBODIMENTS

Hereinafter, embodiments of the present invention will be described with reference to the drawings.

A. System Configuration

Configuration of Main part of Digital Camera

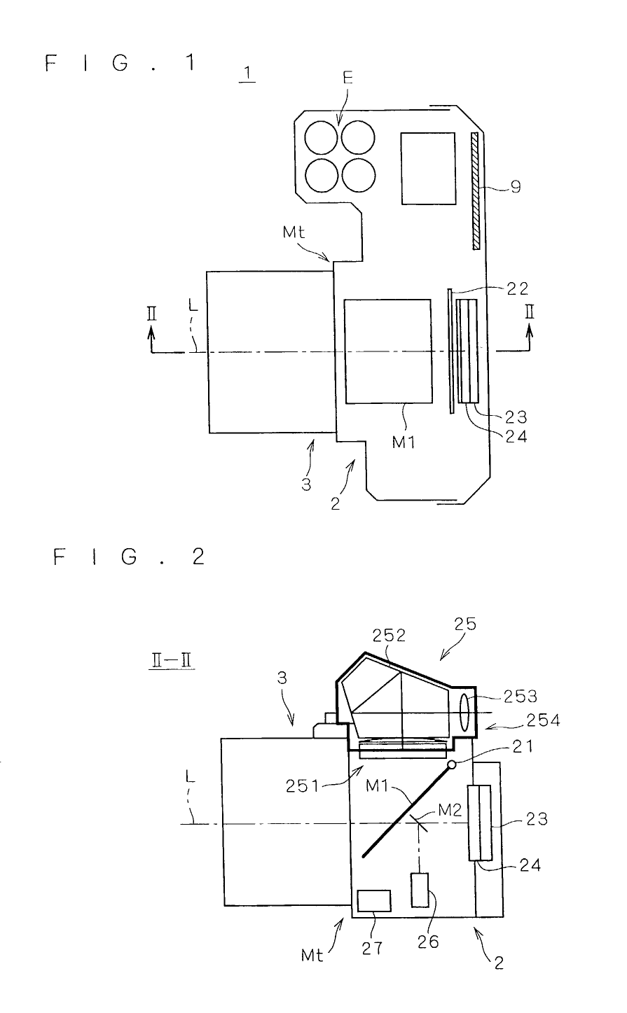

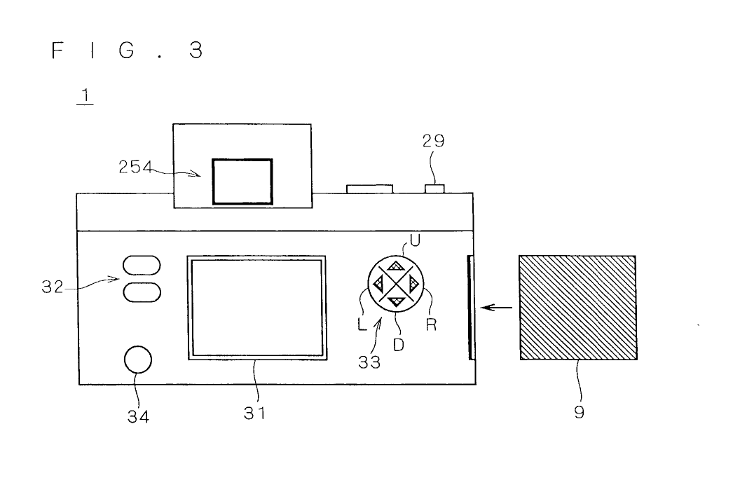

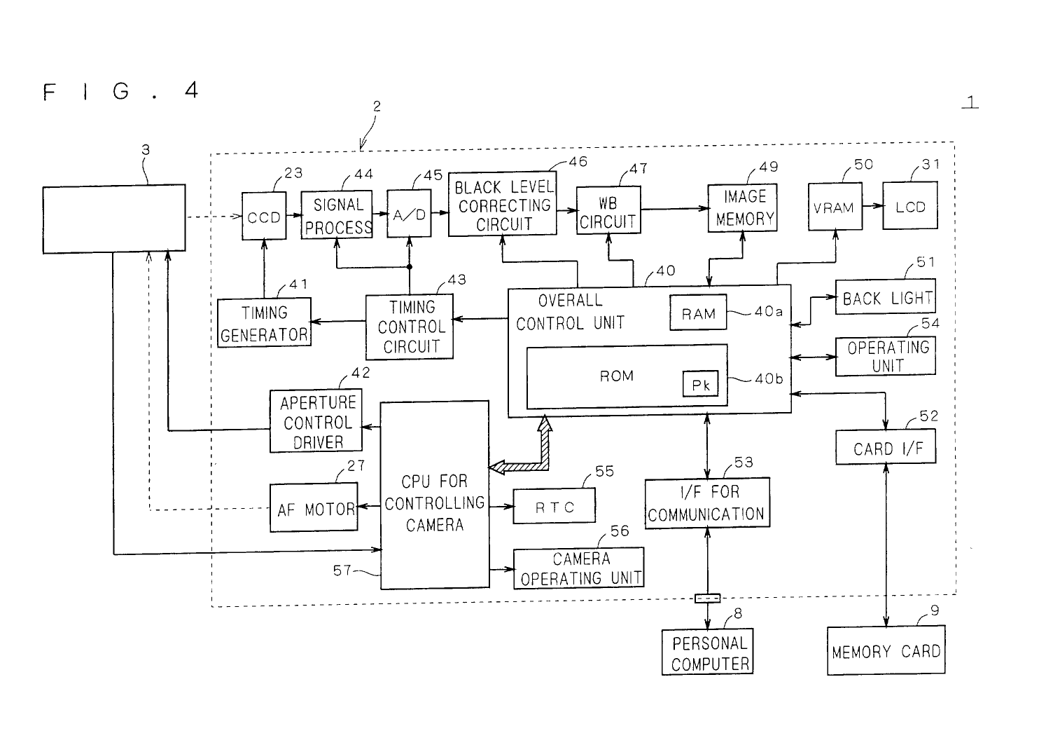

FIGS. 1 to 3 are diagrams showing a configuration of a main part of a digital camera 1 according to a first embodiment of the present invention, respectively. FIG. 1 is a plan view, FIG. 2 is a sectional view taken along line II-II of FIG. 1, and FIG. 3 is a rear view of the digital camera 1. The views are not always according to third angle system but are intended to conceptually illustrate the configuration of the main part of the digital camera 1.

The digital camera 1 has a camera body 2, in which the same configuration as that of a film camera except for unique parts of a digital camera is employed, and an interchangeable lens 3 which can be attached/detached to/from a lens mount portion Mt of the camera body 2.

On the rear side in the optical axis direction L of the interchangeable lens 3, a quick return mirror M1 pivoted by a pivot 21 in the upper rear part of the camera body 2 so as to be swingable is disposed. Further, on the rear side in the optical axis direction L of the quick return mirror M1, a focal plane shutter 22 and a CCD 23 of a color area sensor are sequentially disposed.

On the front face of the CCD 23, a spatial low pass filter 24 suppressing an influence of aliasing noise at the time of sampling an analog image signal from the CCD 23 is disposed.

In the camera body 2, above the quick return mirror M1, an optical system 25 constructing a viewfinder is formed. In the optical system 25, a pentagonal roof prism 252 is provided via a focusing screen 251. An eyepiece 253 is disposed between the pentagonal roof prism 252 and a viewfinder window 254. By the quick return mirror M1, pentagonal roof prism 252 and eyepiece 253, the optical viewfinder is formed.

In the case of performing automatic focusing in the digital camera 1, until a shutter start button 29 is depressed by the user, the quick return mirror M1 is in a stationary position where it is inclined at an angle of 45° with respect to the optical axis as shown in FIG. 2 and makes the optical axis L of the interchangeable lens 3 directed toward the focusing screen 251. When the shutter start button 29 is depressed, the quick return mirror M1 swings upward to almost the horizontal position around the pivot 21 as a center to thereby open the optical path of the interchangeable lens 3.

A sub mirror M2 is a mirror pivoted on a near surface of the quick return mirror M1, by which an optical image passing through a semitransparent mirror part partially provided for the quick return mirror M1 is sent to a focus detecting sensor 26. The focus detecting sensor 26 detects the focus state of (the lens units included in) the interchangeable lens 3 to make the lens unit housed in the interchangeable lens 3 achieve focus.

The camera body 2 has therein a focus motor 27 for driving a focus lens unit included in the interchangeable lens 3 to the optical axis direction L. Four cells E for supplying power to the digital camera 1 and a memory card 9 for recording image data captured and the like can be loaded into the camera body 2.

A liquid crystal display (LCD) 31 for displaying an image captured on the basis of an output of the CCD 23 is provided in the rear face of the camera body 2, and a change-over switch 32 for switching and setting an “image capturing mode”, a “reproduction mode” and the like is provided. The image capturing mode is a mode of capturing a picture. The reproduction mode is a mode of reproducing image data recorded on the memory card 9 and displaying the reproduced image on the LCD 31.

A cross key 133 is provided in the right part of the rear face of the digital camera 1, and various operations are performed by buttons U, D, L and R. As will be described later, in a screen (FIG. 8) for designating a color correction mode (in the embodiment, also referred to as a “special image capturing mode”) displayed on the LCD 31, by moving the cursor by operating the cross key 33, a color correction mode for a captured image can be designated from the plurality of color correction modes.

A power supply switch 34 for turning on/off the power source of the digital camera 1 is provided in the rear face of the camera body 2.

Functional Blocks of Digital Camera 1

FIG. 4 is a functional block diagram of the digital camera 1.

The CCD 23 photoelectrically converts an optical image of a subject formed by the interchangeable lens 3 into image signals having color components of R (red), G (green) and B (blue) (signals of a sequence of pixel signals received by pixels) and outputs the image signals. That is, the CCD 23 generates the image data of the subject. A timing generator 41 generates various timing pulses for controlling the driving of the CCD 23.

Exposure control in the digital camera 1 is performed by adjusting the aperture size of an aperture stop in the interchangeable lens 3 by an aperture control driver 42 and an exposure amount of the CCD 23, that is, charge accumulation time of the CCD 23 corresponding to a shutter speed.

The timing generator 41 generates a drive control signal for the CCD 23 on the basis of a reference clock transmitted from a timing control circuit 43. The timing generator 41 generates, for example, timing signals of start and end of integration (start and end of exposure) and clock signals such as read control signals (a horizontal sync signal, a vertical sync signal, a transfer signal and the like) of light reception signals of pixels and outputs the signals to the CCD 23.

A signal processing unit 44 performs a predetermined analog signal process on an image signal (analog signal) outputted from the CCD 23. The signal processing unit 44 has therein a CDS (Correlated Double Sampling) circuit and an AGC (Auto Gain Control) circuit. Noise of an image signal is reduced by the CDS circuit and the gain of the AGC circuit is adjusted, thereby adjusting the level of an image signal.

An A/D converter 45 converts each pixel signal of the image signal to a digital signal of, for example, 12 bits. The A/D converter 45 converts each pixel signal (analog signal) to a 12-bit digital signal on the basis of a clock for A/D conversion inputted from the timing control circuit 43.

The timing control circuit 43 for generating clocks for the timing generator 41 and A/D converter 45 is provided. The timing control circuit 43 is controlled by a reference clock from an overall control unit 40.

A black level correcting circuit 46 corrects the black level of an A/D converted pixel signal to a reference black level. A WB (White Balance) circuit 47 performs level conversion of the pixel value of each of color components of R, G and B. The WB circuit 47 shifts the level of pixel data of each of the color components of R, G and B by using a level conversion table inputted from the overall control unit 40. A parameter (gradient of a characteristic) of each color component in the level conversion table is automatically or manually set for each captured image by the overall control unit 40.

An image memory 49 is a memory for storing pixel data outputted from the WB circuit 47. A VRAM 50 is a buffer memory of image data displayed on the LCD 31. A back light 51 supplies light to the rear face of the LCD 31.

In a reproduction mode of the digital camera 1, image data read from the memory card 9 is subjected to a predetermined signal process in the overall control unit 40. After that, the resultant data is transferred to the VRAM 50 and reproduced and displayed on the LCD 31.

A card I/F 52 is an interface for writing/reading image data to/from the memory card 9. An I/F 53 for communication is an interface conformed with, for example, the USB standard for external connection to a personal computer 8 so as to perform communications. A control program recorded on the memory card 9 or a recording medium such as a CD-ROM can be stored into a memory of the overall control unit 40 via the card I/F 52 and I/F 53 for communication.

An operating unit 54 is constructed by the change-over switch 32, the cross key 33 and the like.

An RTC 55 is a clock circuit for managing date of image capturing and is driven by not-shown another power source.

A camera operating unit 56 is mainly constructed by the shutter start button 29, the power supply switch 34 and the like related to an image capturing operation of the digital camera 1.

The shutter start button 29 is a two-stage switch capable of detecting a half depressed state (referred to as S1 state) and a fully depressed state (referred to as S2 state). When the shutter start button 29 is set in the S1 state in the standby mode, lens driving for AF is performed by the AF motor 27.

A CPU 57 for controlling a camera is connected to the overall control unit 40 so as to transmit data and is provided for mainly controlling camera operations equivalent to those in a single-lens reflex camera using a film.

The overall control unit 40 has a CPU and a memory (a RAM 40a) and is organically connected to the components of the digital camera 1 to control the operations of the digital camera 1. The overall control unit 40 also has a ROM 40b in which an ICC (International Color Consortium) profile (that is, color conversion data) Pk corresponding to the camera body 2 is stored. The digital camera 1 has, as the ICC profiles Pk, an ICC profile for color data and an ICC profile for monochrome data. The ICC profiles will be described later.

The overall control unit 40 performs various color correcting processes according to color correction modes of captured images on image data (captured image data) to be stored into the image memory 49. Corrected image data is stored into the image memory 49. The overall control unit 40 also performs a setting operation for associating various color conversion data according to the color correction modes. The color correcting process and setting operation will be described later.

When image capturing is instructed by the shutter start button 29 in the image capturing mode, the overall control unit 40 generates a thumbnail image and a compressed image compressed according to the JPEG system at a set compression ratio, both of which are of an image stored in the image memory 49 after the image capturing instruction was given. Further, the overall control unit 40 stores both of the images into the memory card 9 together with tag information regarding the captured images (information such as frame number, exposure value, shutter speed, compression ratio, date of image capturing, data of the on/off state of electronic flash at the time of image capturing, scene information, and a result of determining an image).

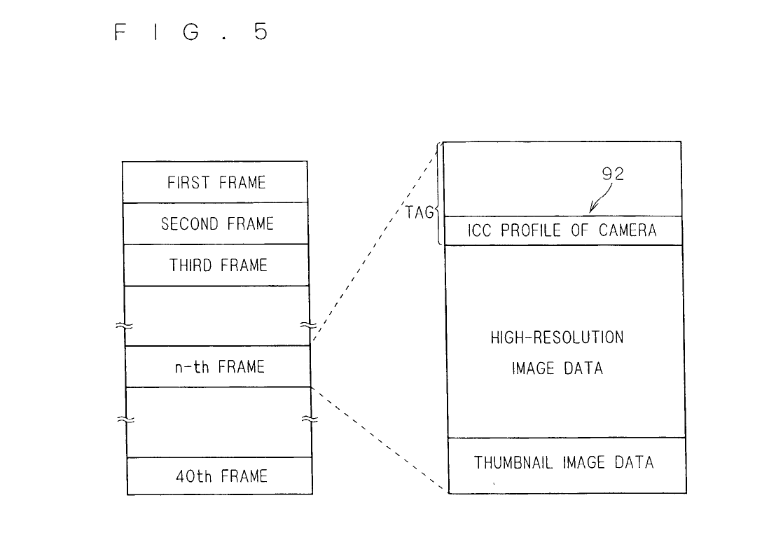

In the memory card 9, as shown in FIG. 5, an image recorded by the digital camera 1 can be compressed and stored. In each frame, the tag information part, an image signal of high resolution (with 1600×1200 pixels) compressed in the JPEG format, and an image signal for displaying a thumbnail (with 80×60 pixels) are recorded. In the tag information part, a camera profile (ICC profile) 92 related to the digital camera 1 is recorded so as to be associated with image data in accordance with the type of the image correction mode. As will be described later, according to the type of the designated color correction mode, it is set to inhibit association with the ICC profile (color conversion data), in other words, it is set so that any ICC profile is not associated with a captured image and stored. When such a setting is made, as the camera profile (ICC profile) 92, no ICC profile is associated with the captured image data and recorded.

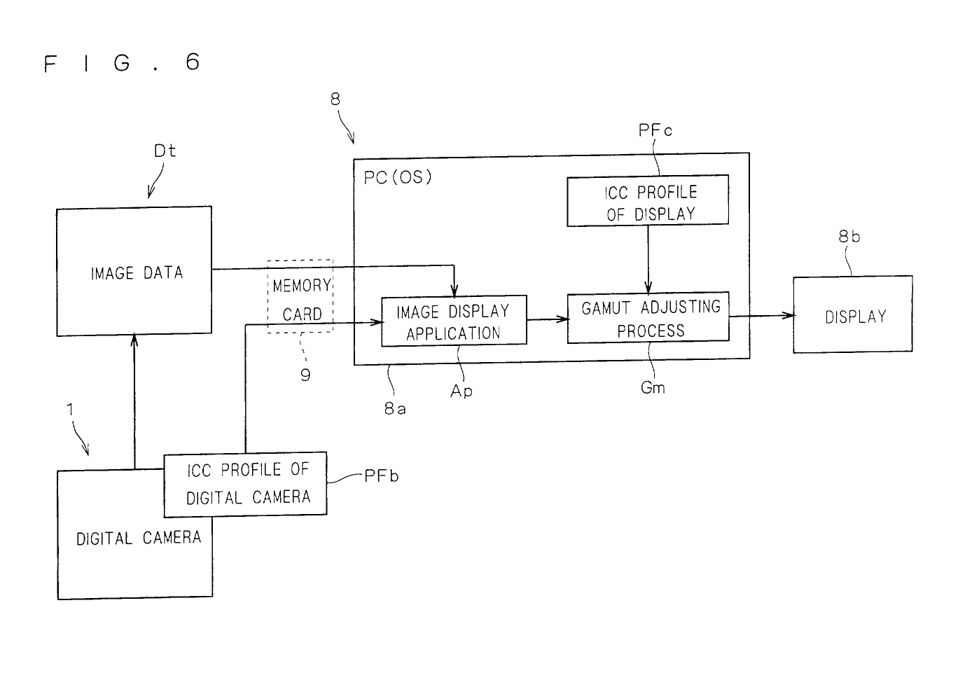

FIG. 6 is a diagram for describing an example of use of the profile.

Image data Dt captured by the digital camera 1 and an ICC profile PFb of the camera body 2 associated with the image data Dt are inputted to the personal computer 8 via, for example, the memory card 9. Subsequently, in an image display application Ap started by a personal computer body 8a, color conversion in which color conversion information of the ICC profile PFb is reflected is performed on the image data Dt. When there is no ICC profile PFc associated with the image data Dt, the image of the image data Dt is displayed on a display 8b without subjected to color conversion with the ICC profile.

After that, the application shifts to a gamut adjusting process Gm. In the gamut adjusting process Gm, an image process in which the ICC profile PFc of the display 8b is reflected is performed, so that an image having proper color reproduction is displayed on the display 8b.

Process according to Color Correction Mode

The digital camera 1 can perform the following three color correcting processes on a normal captured image. Therefore, the digital camera 1 has total four color correction modes, which consist of three modes each for performing a color correcting process on a captured image and a mode for performing no color correcting process on a captured image (hereinafter, also referred to as “special image capture OFF” modes).

The first color correcting process is a color correcting process for correcting captured image data to a monochrome image. A mode of performing such a color correcting process will be referred to as a “black and white” mode.

The second color correcting process is a saturation changing process for changing the saturation of captured image data. A mode of performing such a color correcting process will be referred to as a saturation changing mode. In the saturation changing process, a saturation emphasizing process for emphasizing saturation of captured image data will be described here. The mode of performing the saturation emphasizing process will be referred to as a “saturation emphasizing” mode.

The third color correcting process is a color correcting process for correcting captured image data to an image of sepia color. A mode of performing such a color correcting process will be referred to as a “sepia” mode.

The color correcting processes are realized by the overall control unit 40. The overall control unit 40 calculates a luminance signal Y and color difference signals (R-Y) and (B-Y) on the basis of image signals of color components of R, G and B stored in the image memory 49. The luminance signal Y is calculated by the following equation 1.

Y=Kᵣ·R+K_{g}·G+K_{b}·B (Equation 1)

(where Kᵣ, K_{g} and K_{b} are coefficients)

The overall control unit 40 performs the color correcting process according to the color correction mode by using the signals.

First, processes in the saturation emphasizing mode will be described. The overall control unit 40 performs the saturation emphasizing process by the following equation 2.

$$( \begin{matrix}g \\ h\end{matrix} ) = ( \begin{matrix}a & b \\ c & d\end{matrix} ) ( \begin{matrix}R - Y \\ B - Y\end{matrix} ) + ( \begin{matrix}e \\ f\end{matrix} ) \qquad ( Equation 2 )$$

Variables g and h are values after correction of color difference signals (R-Y) and (B-Y), respectively. “a” to “f” denote variables. By properly adjusting values of the variables (a, b, c, d, e and f), the saturation by the color difference signals (R-Y) and (B-Y) is adjusted. For example, by increasing the value of “a”, red is emphasized. By increasing the value of “d”, blue is emphasized. In this case, values of a correction term (e, f) are usually (0, 0). Based on the principles, the saturation emphasizing process is performed.

A process in the black and white mode will now be described. In the black and white mode (in other words, gray scale mode), by setting (a, b, c, d, e, f)=(0, 0, 0, 0, 0, 0), the computation of Equation 2 is executed. By the computation, the color difference signal (g, h) becomes (0, 0), so that saturation is eliminated and an image comes to have no color. Based on such principles, a process of correcting a captured image to a monochrome image is performed.

Further, a process in the sepia mode will be described. In the sepia mode, a process of fixing the hue of a captured image to a predetermined hue of sepia color (or also expressed as reddish brown) is performed. By setting (a, b, c, d, e, f)=(0, 0, 0, 0, E, F) and computing Equation 2, the process is performed. (E, F) are set to a color difference signal (fixed value) corresponding to the preset sepia color (reddish brown). As the result of computation of Equation 2, the color difference signals “g” and “h” after correction become E and F, respectively (g=E, h=F). Based on such principles, a process of correcting a captured image to an image of sepia color is performed.

B. Operations

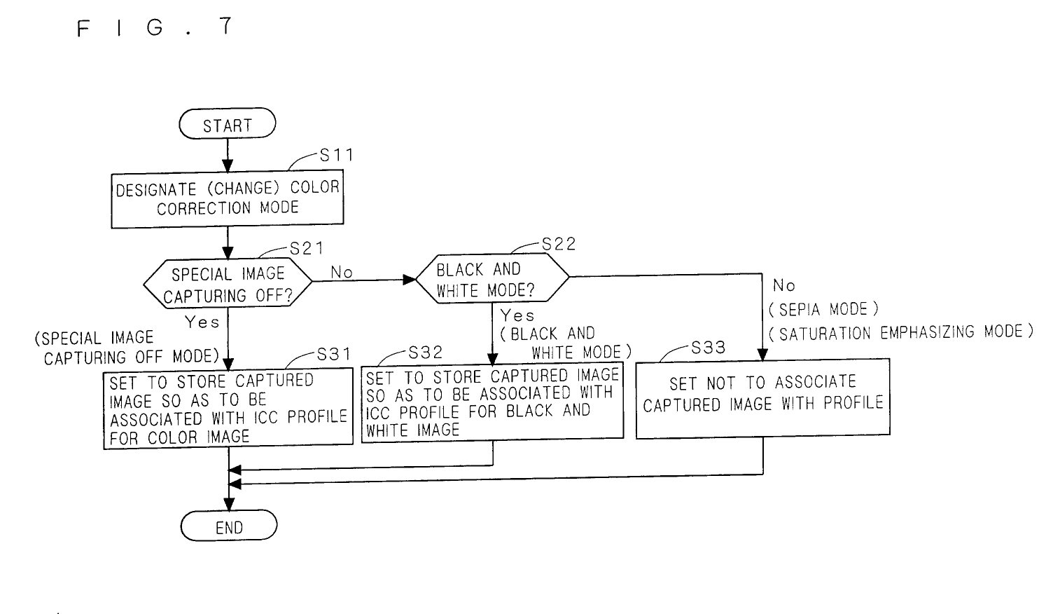

By referring to the flowchart of FIG. 7, a designating operation regarding the color correction mode, a setting operation regarding association of the ICC profile according to the designating operation, and the like will be described. The operations are performed prior to an image capturing operation.

First, in step S11, the color correction mode for captured image data is designated from a plurality of color correction modes. Concretely, when the user of the digital camera 1 performs a predetermined operation, for example, an operation of continuously depressing the change-over switch 32 for a predetermined period (approximately 3 seconds), a screen for receiving an instruction of changing a special image capturing mode (that is, color correction mode) (hereinafter, also referred to as a color correction mode designation screen) as shown in FIG. 8 is displayed on the LCD 31, and the user selects a desired color correction mode from the plurality of color correction modes displayed on the screen. More specifically, the user moves a flashing cursor CS by operating the button 33 (U, D or the like) and can determine selection of the color correction mode in the position of the flashing cursor CS by the button L. In such a manner, any of the color correction modes is designated by the user. FIG. 8 illustrates a case where a desired color correction mode is selected from four options (“special image capturing OFF” mode, “black and white” mode, “saturation emphasizing” mode, and “sepia color” mode).

In steps S21 and S22, a branching process according to the designated color correction mode is performed. Specifically, when the “special image capturing OFF” mode is designated, the program advances to step S31. When the “black and white” mode is designated, the program advances to step S32. When other modes (that is, the “saturation emphasizing” mode and the “sepia” mode) are designated, the program advances to step S33.

For example, when the “special image capturing OFF” mode is designated in step S11, the program advances to step S31. In step S31, it is set that the ICC profile for color image is associated with a captured image. The setting information is stored as parameter information (or flag information) for setting that the ICC profile for color image is associated with the captured image data in a predetermined area in the RAM 40a of the overall control unit 40. The ICC profile for color image is normal color conversion data (ICC profile) used for reproducing faithful colors in consideration of the color reproduction peculiar to the digital camera 1. Concretely, the ICC profile for color image is determined as a profile indicating the correspondence relation between each of the color components R, G and B in the RGB calorimetric system depending on a device and values of components (X, Y, Z) in a device-independent colorimetric system (for example, the XYZ color notation system).

When the “black and white” mode is designated in step S11, the program advances to step S32. In step S32, it is set so that the ICC profile for black and white image is associated with a captured image and stored. The setting information is stored as parameter information for setting that the ICC profile for black and white image is associated with the captured image data in a predetermined area in the RAM 40a of the overall control unit 40. The ICC profile for black and white image is generated as a profile for expressing a black and white image without colors while performing a gray-scale converting process. The ICC profile for black and white image can be generated as, for example, a profile obtained by setting R component data and B component data in the ICC profile for color image as the same data as the G component data. By using such an ICC profile for black and white image, while faithfully reproducing gray-scale information in consideration of the gray-scale reproduction characteristic peculiar to the digital camera 1, an image can be expressed without using colors.

On the other hand, when the “saturation emphasizing” mode (or “sepia” mode) is designated in step S11, the program advances to step S33. In step S33, it is set so that an operation of associating an ICC Profile (color conversion data) is inhibited, in other words, it is set so that no ICC profile is associated with a captured image. The setting information is stored in a predetermined area in the RAM 40a of the overall control unit 40 as parameter information for setting that association of the ICC profile with captured image data is inhibited.

When any of the processes in steps S31, S32 and S33 is finished, the color correction mode setting operation is finished.

As can be seen from comparison between steps S31 and S32, color conversion data to be associated with each captured image data is set according to the type of the color correction mode designated by the user in step S11. As will be described later, it enables a captured image to be reproduced faithfully to the intention of the user.

As can be seen from comparison between step S31 (or S32) and step S33, it is determined and set whether color conversion data is associated with captured image data or association of color conversion data is inhibited, in accordance with the type of the color correction mode designated by the user in step S11. Consequently, captured image data in the color correction mode requiring no color conversion data can be prevented from being associated with unnecessary color conversion data.

After the setting operation, at the time of actual image capturing, a captured image is stored into the memory card 9. At this time, according to the setting made by the setting operation, the captured image is stored.

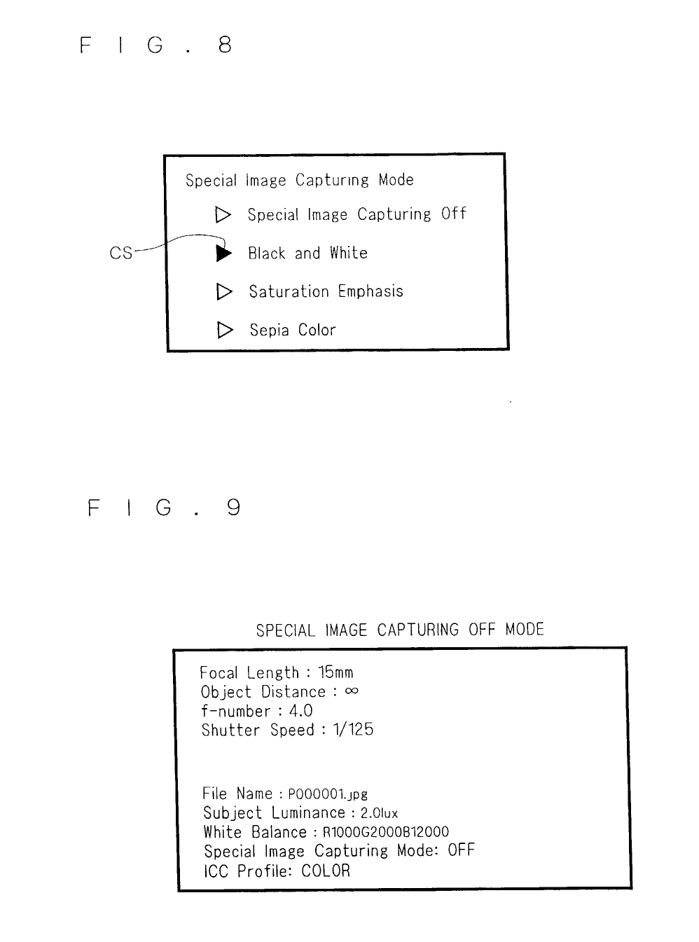

First, the case where the color correction mode is set to the “special image capturing OFF” mode will be described. FIG. 9 is a conceptual diagram showing a detailed configuration of tag information of an image captured in the “special image capturing OFF” mode. FIG. 9 is a diagram showing the tag information portion in data stored in the memory card 9 of a single captured image as shown in FIG. 5.

In the tag information portion, focal length, object distance, aperture value (f-number) and shutter speed at the time of image capturing are stored. In the tag information portion, file name, luminance of subject, white balance, special image capturing mode (color correction mode), information regarding the ICC profile, and the ICC profile itself are also stored.

In this case, it is stored that the “special image capturing OFF” mode is designated as a special image capturing mode (that is, the color correction mode) and, according to the setting operation, the ICC profile for color image as an ICC profile (camera profile) is associated with captured image data and stored.

Regarding an image captured in the “special image capturing OFF” mode, the respective image data subjected to the color correcting process is stored as high-resolution image data and thumbnail image data (see FIG. 5).

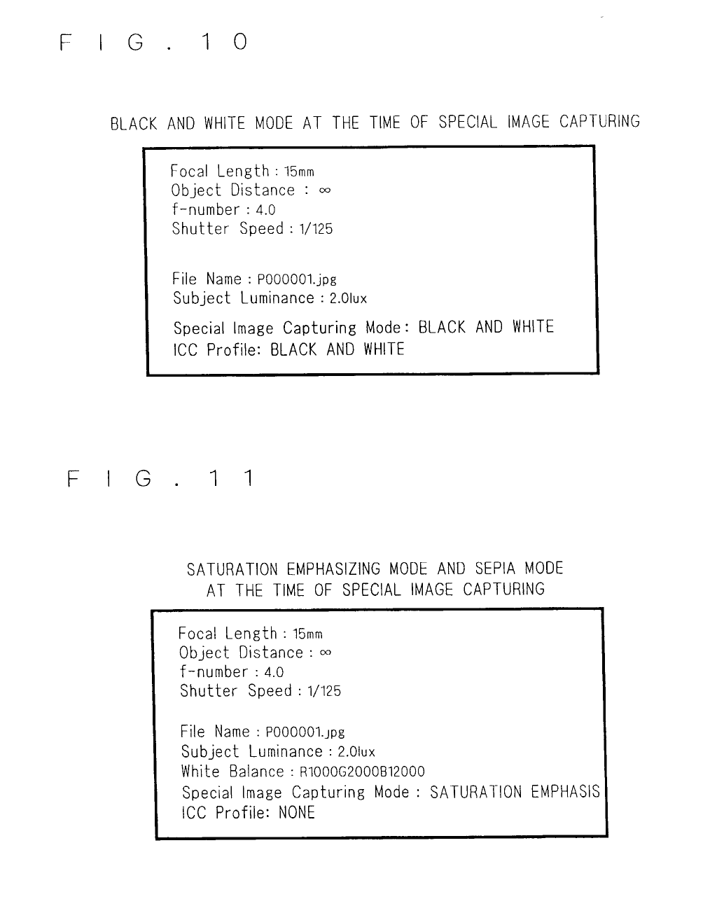

FIG. 10 is a conceptual diagram showing a detailed configuration of tag information for an image captured in the “black and white” mode. As tag information, information similar to that of FIG. 9 except that white balance which is unnecessary for a monochrome image is not recorded is stored.

In the tag information, it is stored that the special image capturing mode is the black and white mode and, in addition, the ICC profile for black and white image is stored. Specifically, according to the setting in step S32, as color conversion data to be associated with captured image data, the ICC profile for black and white image is associated with the captured image data and stored.

Regarding an image captured in the “black and white” mode, the respective image data subjected to the color correcting process in the black and white mode is stored as high-resolution image data and thumbnail image data (see FIG. 5).

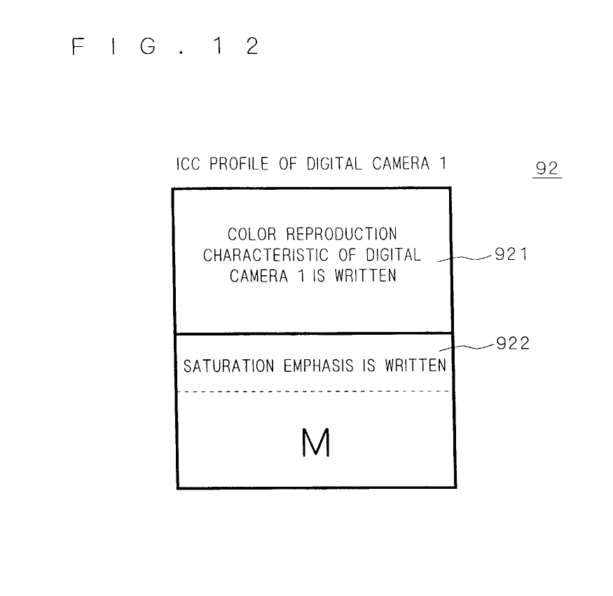

FIG. 11 is a conceptual diagram showing a detailed configuration of tag information for an image captured in the “saturation emphasizing” mode. As tag information, information similar to that of FIG. 9 is stored.

Although it is stored in the tag information that the special image capturing mode is the saturation emphasizing mode, the ICC profile (camera profile) peculiar to the digital camera 1 is not stored. This shows a state reflecting a result of inhibiting association of color conversion data with captured image data in accordance with the setting made in step S33. That is, any ICC profile for camera is not associated with the captured image data.

Regarding an image captured in the “saturation emphasizing” mode, the respective image data obtained by performing the color correcting process in the saturation emphasizing mode is stored as high-resolution image data and thumbnail image data (see FIG. 5).

Since the sepia mode is similar to the saturation emphasizing mode, its detailed description will not be repeated here.

The captured image data stored in the memory card 9 as described above is read by using the computer 8 and displayed on the display 8b of the computer 8 by using the image displaying application Ap.

In the image displaying application Ap, the ICC profile PFb associated with each captured image data is read together with the captured image data, and color conversion in which the color conversion information of the ICC profile PFb is reflected is performed on the image data Dt.

Concretely, when the color correction mode (special image capturing mode) of the image data Dt is set as the “special image capturing OFF” mode, by the ICC profile for color image stored in association with the image data Dt, proper color conversion is performed. When the “black and white” mode is set as the color correction mode of the image data Dt, by the ICC profile for black and white image stored in association with the image data Dt, proper color conversion (gray scale value conversion in this case) is performed. As described above, according to the type of the color correction mode designated by the user, proper color conversion is performed on the image data Dt. As a result, the captured image is reproduced faithfully in accordance with the intention of the user.

When the “special image capturing OFF” mode or “black and white” mode is set as the color correction mode of the image data Dt, the ICC profile (ICC profile for color image or ICC profile for black and white image) stored so as to be associated with the image data Dt exists. However, when the “saturation emphasizing” mode or “sepia” mode is set as the color correction mode of the image data Dt, an ICC profile stored so as to be associated with the image data Dt does not exist.

When the ICC profile (camera profile) associated with the image data Dt exists, color conversion using the ICC profile is performed. When no ICC profile (camera profile) associated with the image data Dt exists, compensation on the color reproduction peculiar to the digital camera 1 with the ICC profile (camera profile) PFb is not performed. Therefore, on the display 8b, an image of the image data Dt which is not subjected to the color conversion with the camera profile is displayed. Concretely, an image of the image data Dt subjected to no color converting process is displayed.

Since the saturation emphasizing process is a process of changing the saturation of a captured image, it may be not so necessary to faithfully reproduce colors of a captured image. That is, there is a case where necessity of performing the color converting process on captured image data subjected to the saturation emphasizing process is low. A process performed on a captured image in the sepia mode is similar to the above.

Therefore, in the embodiment, when the “saturation emphasizing (sepia)” mode is set as the color correction mode of the image data Dt, there is no ICC profile for camera (camera profile) stored so as to be associated with the image data Dt. That is, image data captured in the saturation emphasizing mode is not associated with unnecessary color conversion data. As a result, also in the case of, for example, outputting an image onto the display 8b of the computer 8, an image is outputted without being subjected to color conversion with the ICC profile with respect to the digital camera 1, so that an unnecessary color converting process does not have to be performed. When the “special image capturing OFF” mode or “black and white” mode is set as the color correction mode of the image data Dt, color conversion is performed using the ICC profile (ICC profile for color image or ICC profile for black and white image) stored so as to be associated with the image data Dt.

As described above, in the embodiment, according to the type of the color correction mode designated to the image data Dt, it is set so as to associate the image data Dt with any color conversion data or inhibit association the image data Dt with color conversion data. In the case of the above view, the captured image data can be prevented from being associated with unnecessary color conversion data.

C. Others

In the above described embodiment, the case of making a setting to associate captured image data with the ICC profile for black and white image in the “black and white” mode has been described. However, the present invention is not limited to the case. For example, in the “white and black” mode, a setting that captured image data is not associated with any ICC profile may be made.

In the above described embodiment, four modes are used as color correction modes. The present invention is not limited to the case but can be also applied to a digital camera having modes other than the four modes. For example, the present invention can be also applied to the digital camera 1 having various correction modes including a color correction such as hue rotation.

Further, in the embodiment, color conversion data to be associated with the captured image data is set according to the type of the color correction mode and, after that, the ICC profile PFb (color conversion data) corresponding to captured image data is associated and recorded on the basis of the setting at the time of recording to the memory card 9. Based on the contents of the recording, a captured image is displayed on the display 8b of the computer 8.

Other Embodiments

Other embodiments of the present invention will now be described.

In the above described embodiment, in the case of capturing an image in the “saturation emphasizing mode” in the three types of color correction modes, it is inhibited to associate the ICC profile and the captured image data Dt with each other. However, by dividing the ICC profile into a block 921 for writing the color reproduction characteristic of the digital camera 1 and a block 922 for writing color correction such as the degree of emphasis of saturation designated by the user, even in the case where an image is captured in the “color correction mode” such as the “saturation emphasizing mode”, the ICC profile can be recorded so as to be associated with the captured image data Dt.

The block 921 writing the color reproduction of the digital camera 1 mainly takes the form of an input/output table for every RGB. The block 922 writing the degree of emphasis of saturation mainly takes the form of a matrix M of 3×3 writing saturation conversion, black and white conversion, conversion to sepia color, or special image capturing OFF of each of RGB data.

In the embodiment, different from the above described embodiment, captured image data Dt is recorded without being subjected to a color correcting process such as the saturation emphasizing process or black and white or sepia process. A coefficient is recorded in the matrix M in accordance with color correction designated by the user.

In the image display application Ap, at the time of displaying the image data Dt, a color correcting process designated by the user is performed on the basis of the matrix M, and the color converting process based on the color reproduction characteristic peculiar to the digital camera 1 is performed by the block 921.

By dividing the ICC profile into the block writing the color reproduction characteristic and the block writing the color correction designated by the user, the color correcting process is performed and if the result is not satisfactory, the original colors, what is more, faithful colors considering the color reproduction characteristic peculiar to the digital camera 1 can be reset.

In the embodiment, at the time of reproducing and displaying a captured image on the LCD 31 of the digital camera 1, the conversion matrix M is allowed to act on the captured image data.

The present invention may be embodied by either a computer system controlled in accordance with software programs or a hardware system having individual hardware elements for conducting the respective steps as described in the preferred embodiments. Both of the software elements and the hardware elements are included in the terminology of “parts” which are elements of the system according to the present invention.

While the invention has been shown and described in detail, the foregoing description is in all aspects illustrative and not restrictive. It is therefore understood that numerous modifications and variations can be devised without departing from the scope of the invention.

What is claimed is:

1. A digital camera comprising:
a designating part for designating a color correction mode for captured image data from a plurality of color correction modes; and
a setting part for setting color conversion data to be associated with said captured image data in accordance with the type of the color correction mode designated by said designating part.

2. The digital camera according to claim 1, wherein
said color conversion data includes a part which is changed according to said designated color correction mode and a part in which a color reproduction characteristic peculiar to said digital camera is written.

3. A digital camera comprising:
a designating part for designating a color correction mode for captured image data from a plurality of color correction modes; and
a setting part for setting whether color conversion data is associated with said captured image data or inhibited to be associated, in accordance with the type of the color correction mode designated by said designating part.

4. The digital camera according to claim 3, wherein
said plurality of color correction modes include a saturation changing mode of changing saturation of said captured image data.

5. The digital camera according to claim 3, wherein
said plurality of color correction modes include a sepia mode of correcting said captured image data to a sepia image.
